(19) United States
(12) Patent Application Publication
(10) Pub. No.: US 2019/0244161 A1
(43) Pub. Date: Aug. 8, 2019

(54) INVENTORY CONTROL

(71) Applicant: Microsoft Technology Licensing, LLC, Redmond, WA (US)

(72) Inventors: Abhishek ABHISHEK, Sammamish, WA (US); Rouzbeh AMINPOUR, Bellevue, WA (US); Yasser B. ASMI, Redmond, WA (US); Zhengyou ZHANG, Mercer Island, WA (US); Ali DALLOUL, Newcastle, WA (US); Jie LIU, Medina, WA (US); Di WANG, Sammamish, WA (US); Dimitrios LYMBEROPOULOS, Kirkland, WA (US); Michel GORACZKO, Seattle, WA (US); Yi LU, Sammamish, WA (US); William THOMAS, Redmond, WA (US)

(73) Assignee: Microsoft Technology Licensing, LLC, Redmond, WA (US)

(21) Appl. No.: 15/887,967

(22) Filed: Feb. 2, 2018

(51) Int. Cl. G06Q 10/08; G06K 19/07; G06Q 30/06

(52) U.S. Cl. CPC G06Q 10/087; G06Q 30/0639; G06K 19/0723

(57) ABSTRACT

The discussion relates to inventory control. One example can analyze data from sensors to identify items and users in an inventory control environment. The example can detect co-location of an individual user and an individual item at a first location in the inventory control environment at a first time and at a second location in the inventory control environment at a second time.

### BRIEF DESCRIPTION OF THE DRAWINGS

The accompanying drawings illustrate implementations of the concepts conveyed in the present patent. Features of the illustrated implementations can be more readily understood by reference to the following description taken in conjunction with the accompanying drawings. Like reference numbers in the various drawings are used wherever feasible to indicate like elements. In some cases, parentheticals are utilized after a reference number to distinguish like elements. Use of the reference number without the associated parenthetical is generic to the element. Further, the left-most numeral of each reference number conveys the figure and associated discussion where the reference number is first introduced.

FIGS. 1A-1D, 2A-2E, and 3 collectively show inventory control example scenarios in accordance with some implementations of the present concepts.

FIG. 4 shows a schematic representation of a particle filter sensor fusion technique in accordance with some implementations.

FIGS. 5-6 show flowcharts of example methods that can implement some of the present concepts in accordance with some implementations.

FIG. 7 shows an example inventory control system in accordance with some implementations of the present concepts.

### DETAILED DESCRIPTION

This description relates to friction-free inventory control concepts. Existing inventory controls tend to be ineffective (e.g., inaccurate) and/or burdensome to users involved with them. The following description offers friction-free inventory control that can be implemented nearly seamlessly for users. These inventory control concepts can be implemented in almost any use case scenario that involves tracking locations of items, objects, and/or users and/or their inter-relationships in a physical environment. For purposes of explanation, the description first turns to a retail shopping scenario, followed by a construction/manufacturing scenario, and finally a health care scenario.

Traditionally, in retail shopping scenarios, inventory control has been accomplished manually by forcing the user to go through a check stand where a clerk either manually enters, or electronically scans the user's items. The user then pays the clerk for the items before leaving. Waiting in a check-out line is frustrating for shoppers and is consistently perceived as the least enjoyable part of shopping. Attempts have been made to reduce these checkout lines by utilizing self-check kiosks. However, the process still has similar pitfalls and users often end up waiting in line for a kiosk and waste time in the check-out process. Often users have trouble with the self-check process which tends to cause delay and results, once again, in longer check out times. More sophisticated attempts to provide a seamless user experience face the daunting technical challenge of unobtrusively and accurately identifying users that are in the inventory control environment and determining what inventory items individual users have in their possession. In light of these and other goals, the present concepts can utilize data from multiple sensors over time to identify users and items and associations therebetween.

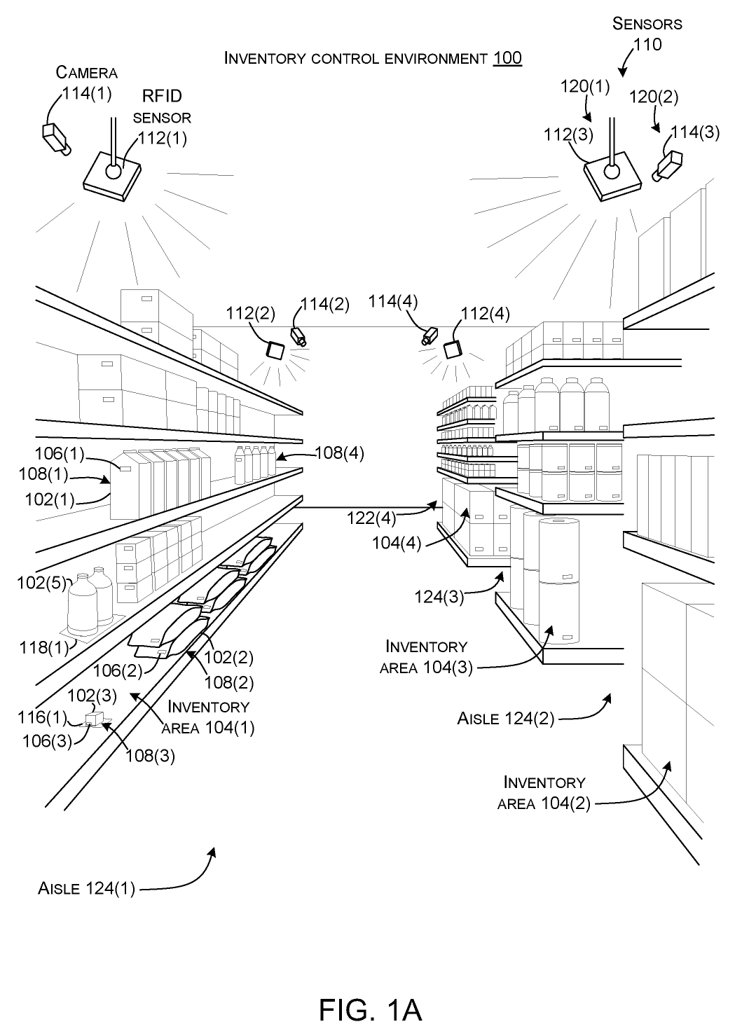

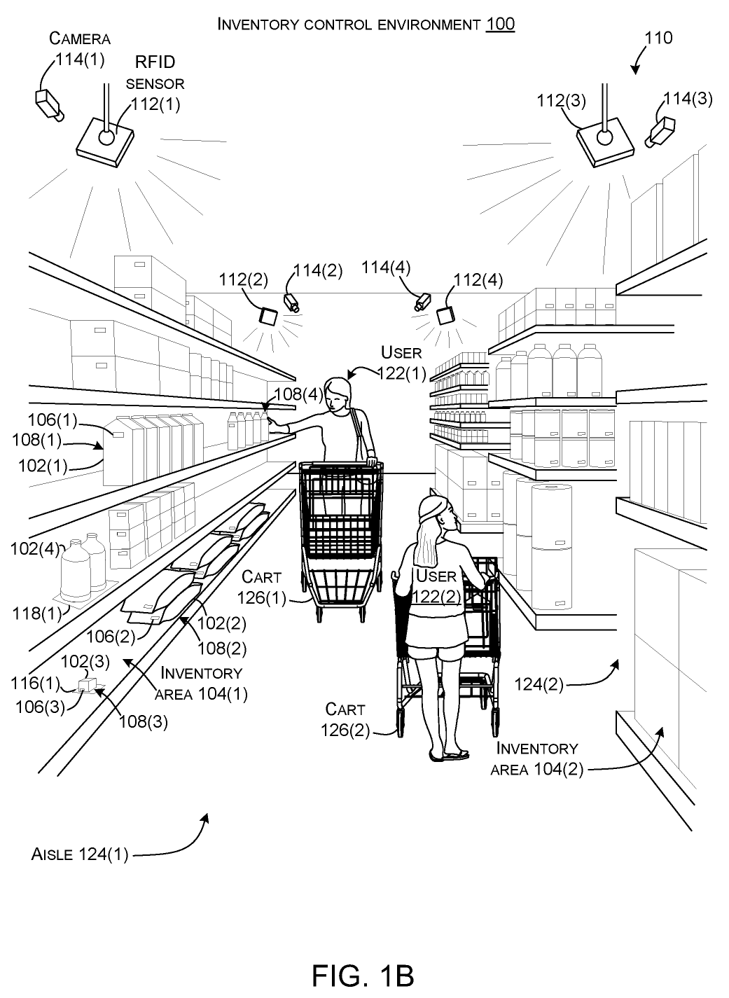

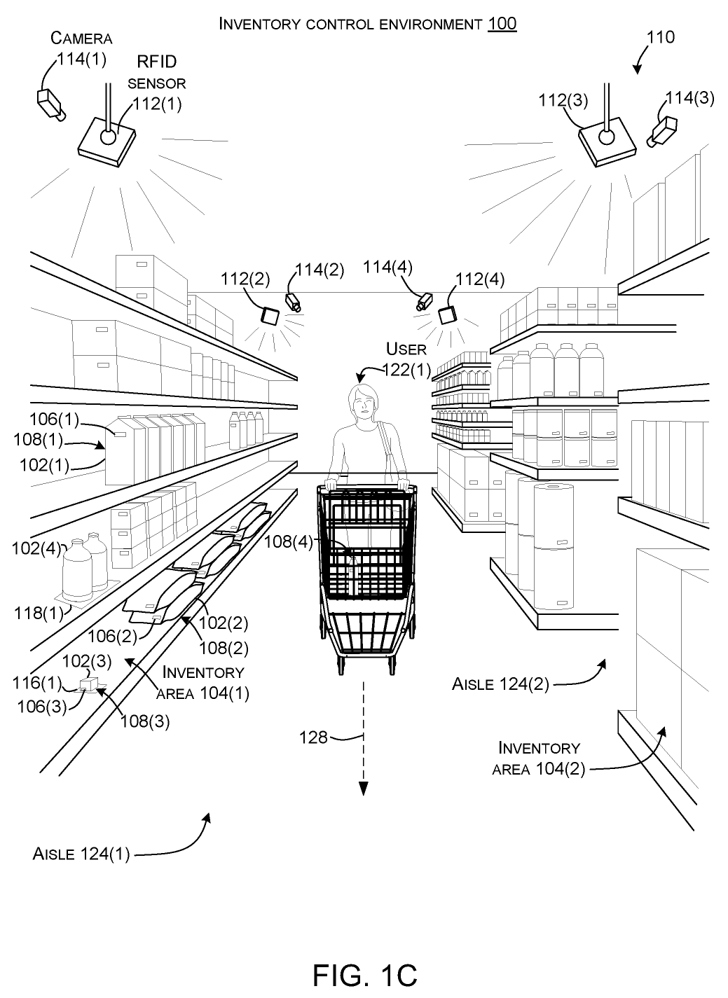

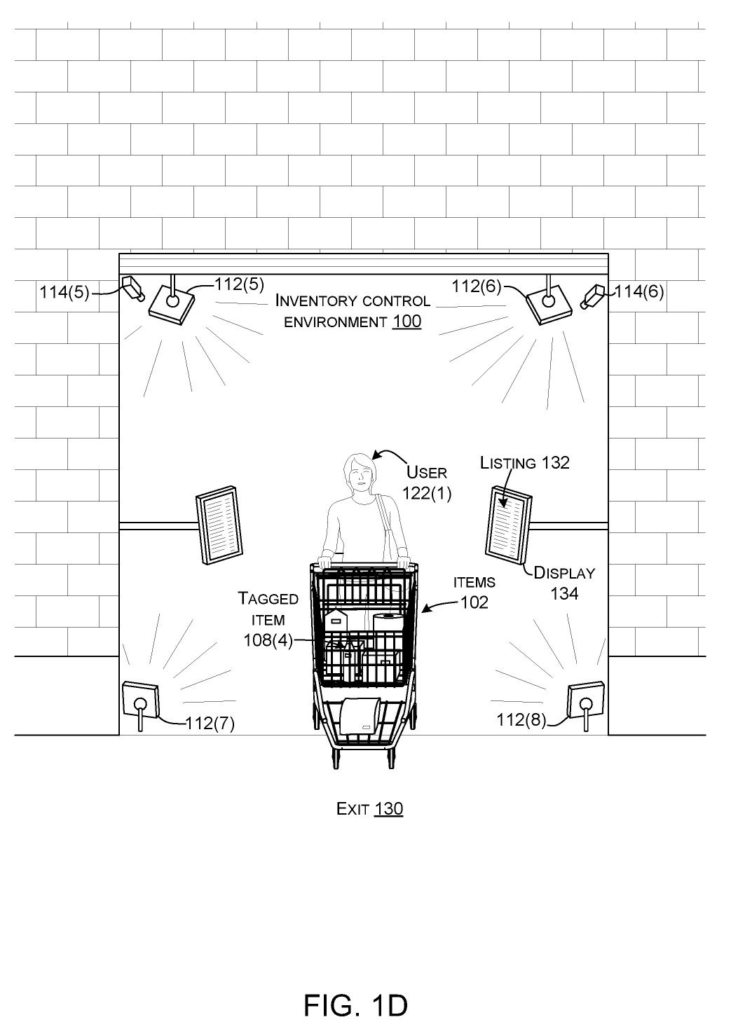

FIGS. 1A-1D collectively show an example inventory control environment 100 that can provide a seamless shopping experience without the checkout hassle. In this case, FIG. 1A shows the inventory control environment includes inventory items 102 that can be positioned in inventory areas 104 (e.g., shelves, racks, etc). Some of the inventory items 102 can be associated with ID tags 106 to create ID tagged inventory items (hereinafter, “tagged items”) 108 (not all of which are indicated with specificity because dozens of items are illustrated). Various types of ID tags can be employed. For example, in the illustrated implementation, example ID tags 106(1) and 106(2) are RFID tags, while example ID tag 106(3) is a near field communication (NFC) tag. In other cases, the ID can be generated by active RF transmissions, sound, and/or using computer vision to identify the object.

The inventory control environment 100 can also include various sensors (indicated generally at 110). In this example, the sensors 110 include RFID sensors (e.g., antennas) 112, cameras 114 (visible light and/or infrared, 2D and/or 3D), NFC sensors 116, and/or weight sensors (e.g., scales) 118, among others. The RFID sensors 112 and NFC sensors 116 can sense tagged items 108. The cameras 114 and weight sensors 118 can sense tagged items 108 and/or untagged items 102.

In some implementations, the sensors 110 can be organized into sets 120 to achieve a given function. For instance, a first set 120(1) can operate to sense items 102, while a second set 120(2) can operate to sense users 122 (FIG. 1B) in the inventor control environment 100. For example, RFID sensors 112 can (alone or collectively) sense individual tagged items 108, such as tagged item 108(1). The second set 120(2) may include cameras 114 for sensing users 122. Further still, individual sensors 110 may be included in both sets. For instance, the cameras 114 may be in the second set 120(2) to sense users 122 and may be in the first set 120(1) to sense items 102. One such example can relate to item 102(5), which is positioned on weight sensor 118(1). If a user picks up item 102(5) (as indicated by defined decrease in weight detected by weight sensor 118(1)), the cameras 114 can track both the user and the item. Thus, each sensor type can provide sensed data about the user and the item. Taken collectively or ‘fused’ the sensed data can provide information about the item and user over time.

FIG. 1B shows users 122 have entered aisle 124(1) of the inventory control environment 100. In this retail shopping scenario, the users 122 are shoppers (and could also be employees). In this implementation, cameras 114 can capture images of the users 122. The images can be used to identify the users. For instance, various biometric parameters from the images may be analyzed to identify the users. For example, face recognition can be employed to identify individual users (e.g., such as against a database of registered shoppers that have biometric data, such as pictures on file). The images can also be used to identify other information about the users. For instance, gestures performed by the user can be identified from the images. For instance, image information could indicate that the user performed a gesture of picking something up, touching, sitting, throwing, looking, etc.

Other implementations may identify the individual users 122 with additional or alternative techniques. For instance, individual users may have their smart phones with them. Communications can be established with the smart phone to identify the user and the user's location can be tracked by tracking the location of the smart phone. In one example, the user may have an app on their smart phone for an entity associated with the inventory control environment 100. The app may include an agreement that defines conditions of use that have been approved by the user. The conditions of use may allow the entity to use the smart phone to identify and track the user when the smart phone is detected in the inventory control environment 100. The app may also define payment aspects (discussed more below). In another example, the user may wear smart wearable devices, such as bands, glasses, belts, and/or rings, to achieve the same capabilities of the smart phones.

Viewed from one perspective, an advantage of the present implementations is the ability to utilize whatever sensor data is available from one or more types of sensors and to analyze this collection of sensed data to obtain information about users, items, and/or relationships between users and items. This process can be termed ‘sensor fusion’ and will be explained in further detail in the discussion below. Sensor fusion can reduce the limitations and uncertainties that come with any type of sensor by combining observations from multiple sensors over space and time to improve the accuracy of determinations about the items and/or users. This improved accuracy can be achieved without inconveniencing the users.

In the inventory control environment 100, the users 122 can interact with various items 102 in a traditional manner. For instance, as illustrated in FIG. 1B, user 122(1) is picking up and examining tagged item 108(4) to decide whether to buy it. The user 122(1) may return tagged item 108(4) to the shelf or decide to keep it, such as by carrying it or placing it in cart 126(1). Input from the available sensors 110 can be fused to determine which user engaged the item and/or whether the user still has the item or not. For instance, information from RFID sensors 112 of the subset (e.g., 112(1)-112(4)) and/or cameras 114 can be used to determine which user (e.g., user 122(1) or user 122(2)) picked up the tagged item 108(4) in this example) and whether the user kept the tagged item or replaced it. Other items can be sensed alternatively or additionally by other sensor types, such as NFC sensors 116, and/or weight sensors 118, among others.

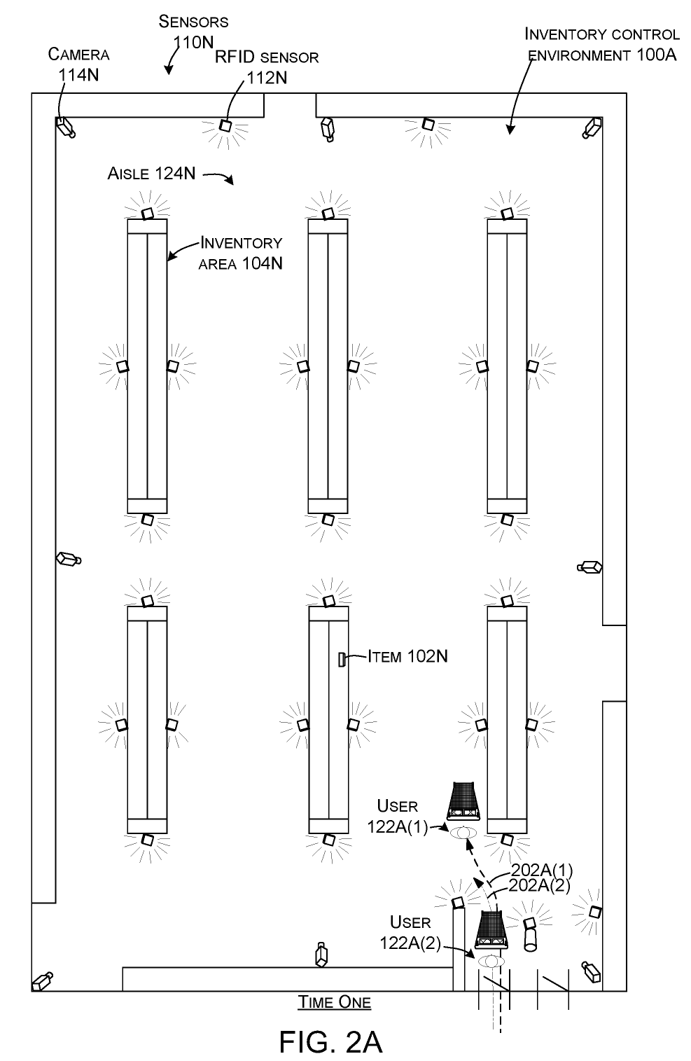

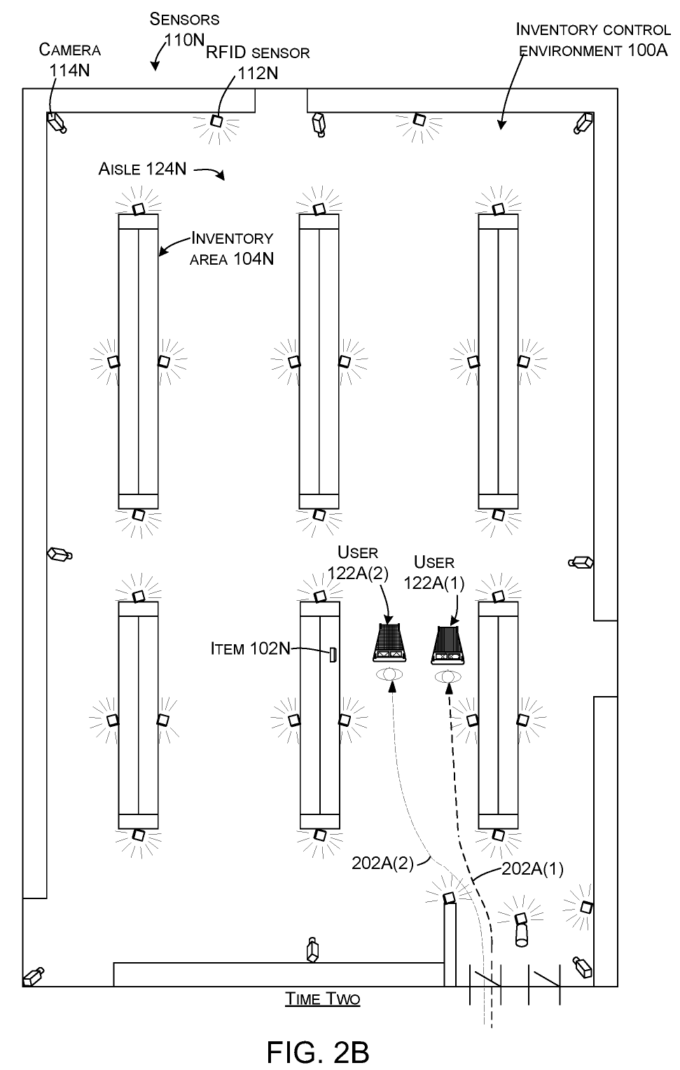

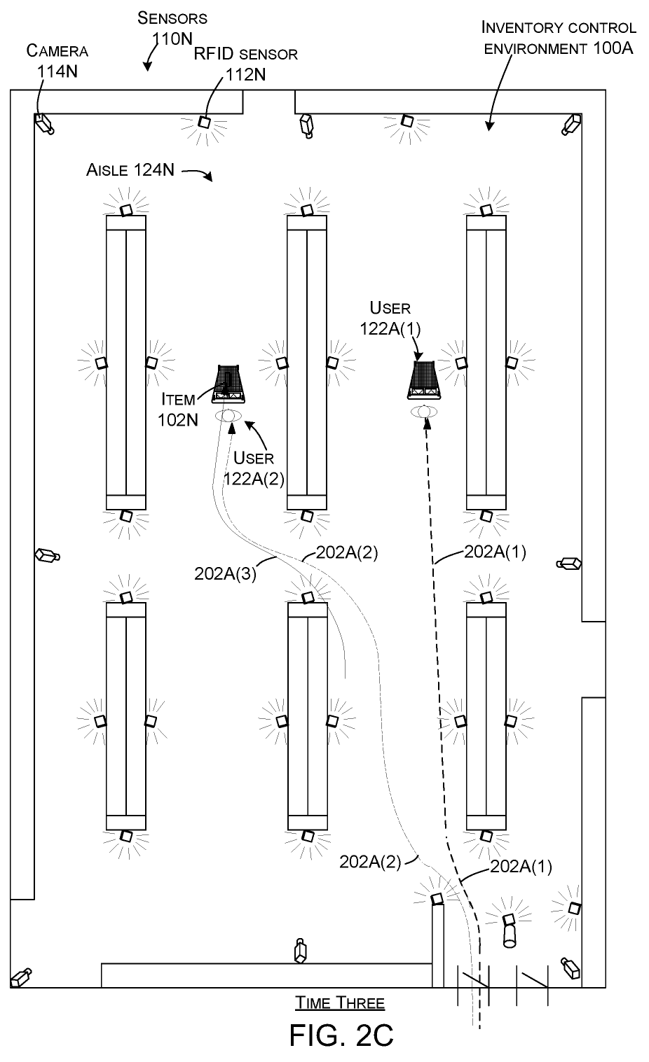

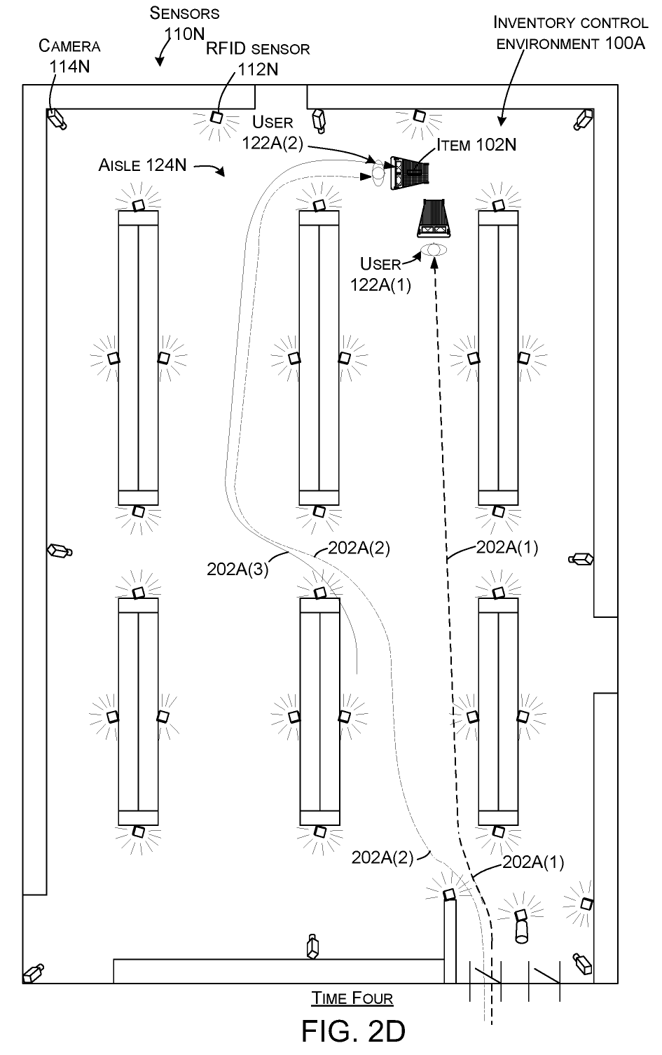

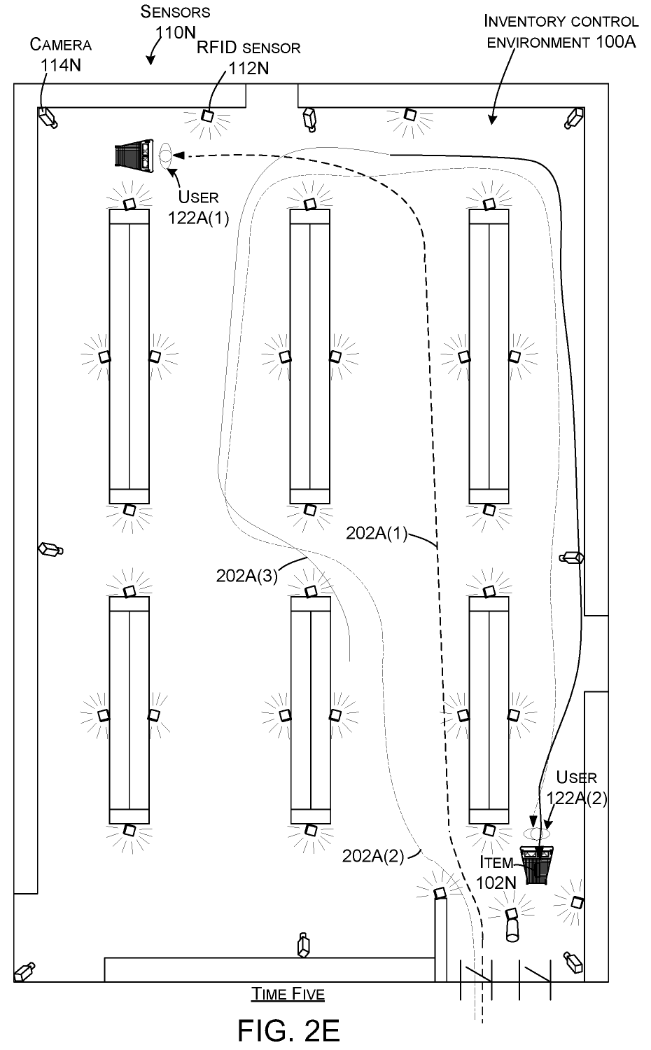

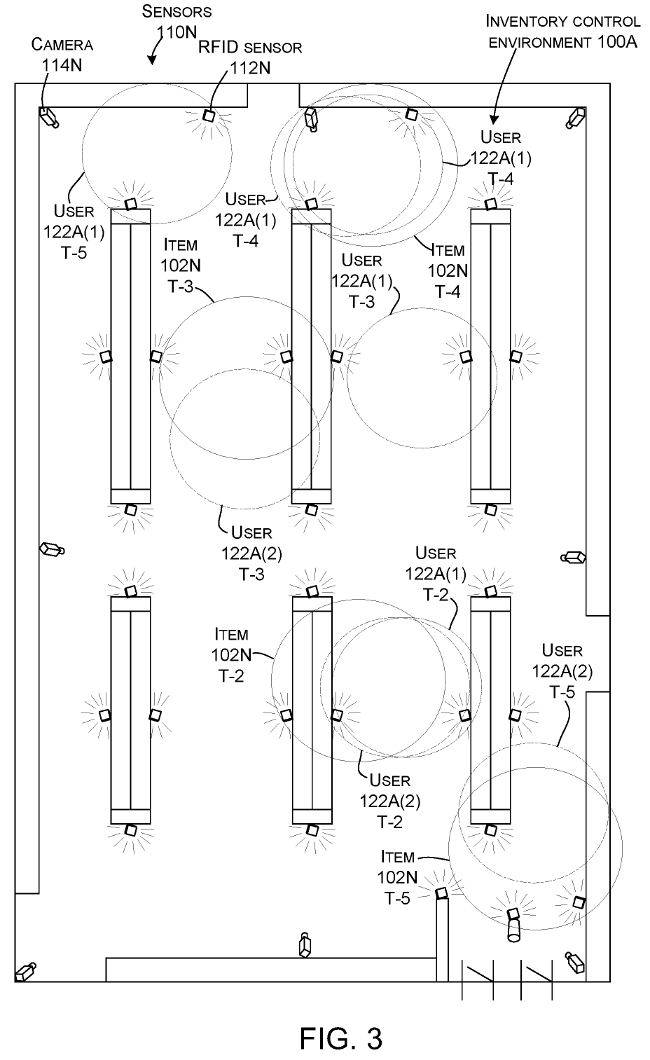

In this example, looking at FIG. 1C, sensors 110, such as RFID sensors 112(1)-112(4) can provide sensed data that can be used to determine that tagged item 108(4) is moving in a direction indicated by arrow 128. Similarly, information from cameras 114 can be used to identify that user 122(1) is moving in the same direction along arrow 128 in close proximity to the location of tagged item 108(4). In contrast, user 122(2) has turned down aisle 124(2) and is no longer visible. This co-location between user 122(1) and tagged item 108(4) can be strongly indicative of user 122(1) being in possession of tagged item 108(4). The longer (e.g., through time and/or distance) this ‘co-location’ occurs the higher the likelihood of that user 122(1) is in possession of tagged item 108(4). Co-location is described in more detail below relative to FIGS. 2A-2E and 3.

FIG. 1D shows user 122(1) in a second location of the inventory control environment 100. In this example, the second location is an exit 130 from the inventory control environment. The second location is covered by (subset of) sensors 110, such as RFID sensors 112(5)-112(8) and cameras 114(5) and 114(6). Sensor fusion of sensed data relating to the user and the items and co-location of the user and the items through the inventory control environment can be utilized to determine that the user 122(1) is in possession of various items 102 including the previously discussed tagged item 108(4).

An action can be taken based upon the user's possession of the items 102 from the first location to the second location. For instance, the user 122(1) can be deemed to want to purchase the items 102 in their possession at the second location. The items 102 in the user's possession can be verified at the second location. For instance, in this example, a listing 132 of the tagged items can be provided to the user, such as on displays 134. The user can verify the listing 132. The user can then be charged for the possessed (and verified) items 102, such as on a credit card account on record for the user or by the user paying cash, EBT, check, or other traditional forms of payment for the items. The payment aspect may be defined according to conditions agreed to by the entity associated with the inventory control environment (e.g., operating entity) and the user, such as by an app on the user's smartphone. In some implementations, the user can continue on her way without the hassle of checkout lines and the shopping experience can be seamless from beginning to end.

FIGS. 2A-2E are schematic views looking down from above that collectively show another inventory control environment 100A and associated use case scenario through a sequence of times (Time One-Time Five). In this example, inventory control environment 100A includes aisles 124N, inventory areas 104N, and sensors 110N, such as RFID sensors 112N and cameras 114N. These elements were discussed in detail above relative to FIGS. 1A-1D and are not re-introduced here in detail for sake of brevity. (The suffix ‘N’ is used generically to convey that any number of these elements may be employed in this example).

The illustrated scenario involves users 122A(1) and 122A(2) and using sensor fusion and co-location to determine which user is in possession of example item 102N. FIG. 2A shows users 122A(1) and 122A(2) entering the inventory control environment 100A at Time One. Some or all of sensors 110N can provide data that can be used to identify the users and track the location of the users.

This implementation is not directed to specific types of sensors 110N and instead can utilize whatever sensor data is available. The available sensor data can be fused together to obtain information about users 122A and items 102N over time. For instance, fused data relating to the users can provide many useful parameters, such as skeletal parameters, facial parameters, heat, footsteps, gait length, pulse, respiration rate, etc. These parameters can be used for distinguishing and/or identifying various users. These parameters can also be used for locating individual users and/or detecting user gestures, such as their motion and/or activity, such as walking and/or picking something up.

Similarly, sensor fusion can provide sensed data relating to the appearance of the items, such as shape, design, color, pattern, size, weight, and/or material. These parameters can be used to identify an item, but can be even more accurate when combined with tag information, such as RFID tags, unique codes, such as Q codes and/or other physically distinctive aspects. The location of individual items can be tracked with vibration/acceleration data, ultra-sound reflection data, and/or displacement in camera field of view, among others.

In the illustrated example, weight sensors, cameras, and RFID sensors can all provide information about whether the item is still on the shelf or not. Once the item is picked up, both the cameras and the RFID sensors can provide data that can be used for determining its location. If the user is holding the item, the cameras may provide more accurate location information than the RFID sensors and as such be weighted higher in determinative value. In contrast, if the user puts the item in a shopping cart and puts other items on top of it, the value of the camera data may decrease and be weighted lower than RFID data. The available sensor data can be collectively evaluated or fused to determine the locations of the users and the items at various times. Consecutive locations can be utilized to track paths 202A(1), 202A(2), and 202A(3) (FIG. 2C) of the respective users and items.

FIG. 2B shows the two users 122A(1) and 122A(2) both proximate to item 102N at Time Two. Assume that either user 122A(1) or user 122A(2) picks up the item and adds it to their cart. Traditionally, sensor data from an instance in time would be analyzed to determine which user has the item 102N. However, such analysis has proven unreliable for reasons mentioned in the discussion above, such as interference caused by the users' bodies and/or the carts, the users reaching around and/or over one another, etc. As will become apparent below, the present implementations can achieve improved reliability by sensing both the user and the item over time. The locations of the users and the item can be determined over time and co-location can be utilized to reliably determine which user has the item. This is illustrated relative to FIGS. 2C-2E.

FIG. 2C shows a subsequent Time Three where item 102N is co-located with user 122A(2) and not with user 122A(1). This is evidenced by comparing the item's path 202A(3) with the users' paths 202A(1) and 202A(2).

FIG. 2D shows a subsequent Time Four where item 102N, user 122A(2), and user 122A(1) are co-located with one another (e.g., intersecting paths 202A(3), 202A(2), and 202A(1).

FIG. 2E shows a subsequent Time Five where item 102N is co-located with user 122A(2) and not with user 122A(1) as indicated by proximity of paths 202A(3) and 202A(2) compared to path 202A(1). At this point, user 122A(2) is preparing to leave the inventory control environment 100A. FIG. 2E also shows an entirety of path 202A(2) belonging to user 122A(2) in the inventory control environment as well as the path 202A(1) of user 122A(1) and path 202A(3) of item 102N. Paths 202A(2) and 202A(3) are co-extensive for much of their length and continue to be co-extensive up to and at the point of leaving the inventory control environment 100. In contrast, path 202A(3) is only co-extensive with path 202A(1) for a short distance when the item was first picked up (FIG. 2B) and the paths crossed (e.g., where co-located) again at FIG. 2D. Otherwise, path 202A(1) of user 122A(1) diverges from path 202A(3) of item 102N during a remainder of the illustrated duration of time (e.g., Time One to Time Five). Thus, based upon paths 202A(1)-202A(3) over time range Time One to Time Five, a determination can be made with high confidence that user 122A(2) is in possession of item 102N and is preparing to leave the inventory control environment with the item. This high confidence determination can be made without relying on a high accuracy determination at any instance of the time range. Thus, the present implementations lend themselves to using whatever sensor data is available and detecting extensive simultaneous co-location (e.g., same place same time).

From one perspective, the illustrated implementation can provide useful information about objects and users through one or more sensor fusion paradigms, such as multi-sensor fusion, temporal-spatial fusion, and/or source separation. For instance, a single event, such as identifying an item is observed/sensed by multiple sensors (in some cases with multiple modalities per sensor). The observations can be fused together to provide a more accurate identification than can be achieved by a single sensor. For instance, an item can be identified by its size, shape, and/or color (e.g., using multiple cameras from multiple view angles). The item can also be sensed for weight (from a scale beneath it) and/or for composition by a metal detector. In one such example, a metal can of soup can be distinguished from an aluminum can of soda despite similar weights, shapes, and labels.

Temporal-spatial fusion observations of an individual item can be made over time and space. Physical laws (such as motion) and correlations can be used to constrain the possible states of the item and reduce uncertainties. For example, Newton's law can be applied to the sensor data to model the trajectory of the item. Given an estimation of the current position and an observation of any applied force, temporal-spatial fusion implementations can estimate the next possible position of the item and its uncertainty.

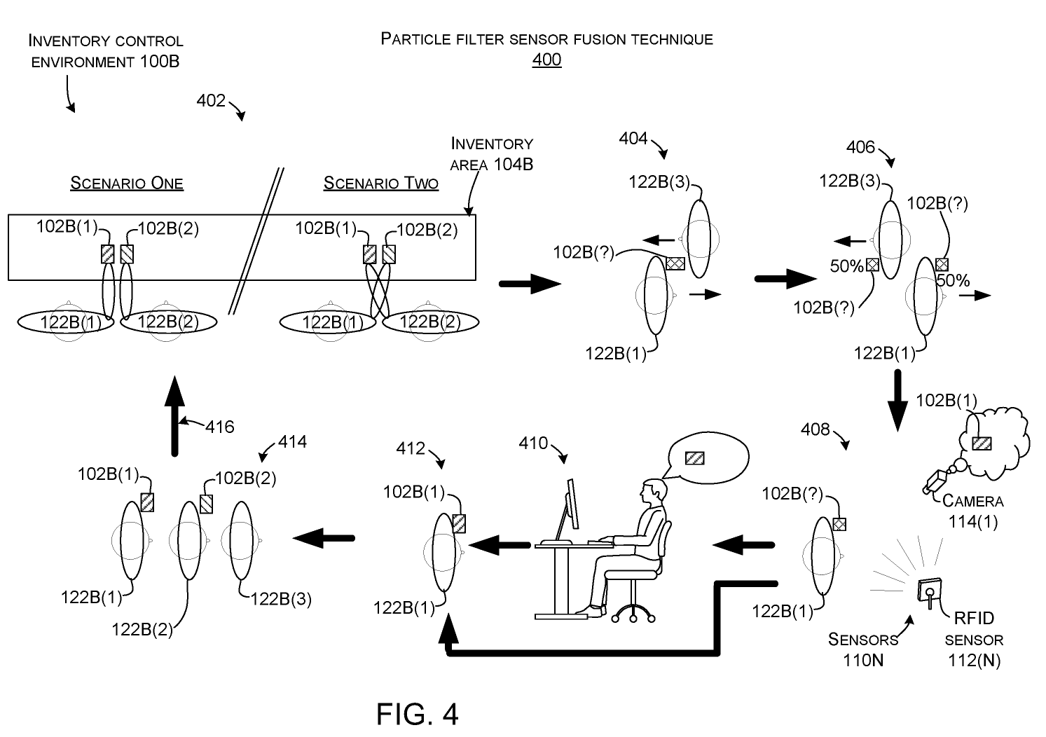

In source separation fusion, an observation of items/users may contain signals from multiple events mixed together. Features can be used to estimate which part of the signal comes from which source (e.g., sensor). For instance, multiple users may be talking at the same time. When sensed with a microphone array, source separation fusion implementations can separate individual users based on the direction of the sound source. The present implementations can employ various fusion algorithms, such as statistics, Bayesian inference, Dempster-Shafer evidential theory, Neural networks and machine learning, Fuzzy logic, Kalman filters, and/or Particle filters. An example Particle filter implementation is described in more detail below relative to FIG. 4.

FIGS. 2A-2E show an implementation where exact paths (e.g., location over time) 202A are determined for users and items in the inventory control environment 100A. FIG. 3 shows an alternative implementation relating to inventory control environment 100A, item 102N, and users 122A(1) and 122A(2). In this case, circles are used to represent approximate locations of item 102N, and users 122A(1) and 122A(2) at Time Two (T−2), Time Three (T−3), Time Four (T−4), and Time Five (T−5). This example is analogous to the example above relating to FIGS. 2A-2E and Time Two is the first instance users 122A(1) and 122A(2) and item 102N are co-located. Any determination about which user is in possession of the item based upon this sensed data tends to have a low confidence level. Subsequent Time Three show that the item is now co-located with user 122A(2), but not with user 122A(1). Then Time Four again shows co-location of the item 102N with both users 122A(1) and 122A(2). Again, any determination about possession based solely on this sensed data at any particular instance in time tends not to have a high confidence.

Time Five shows user 122A(2) once again co-located with the item 102N while user 122A(1) is relatively far from the item 120N and is moving away. When viewed collectively, analysis of the sensed data can indicate that both users were near the item at Time Two, but then at Time Three user 122A(1) moved away from the item while the item moved with user 122A(2). At Time Four, the users were both once again close to the item, but again user 122A(1) moved away from the item while the item moved or tracked with user 122A(2) to checkout at Time Five. Thus, analysis of the sensor data over the time range can indicate that it is much more likely that user 122A(2) is in possession of the item than user 122A(1) and further, user 122A(2) plans to purchase the item.

This accurate determination can be achieved without requiring the locations of the items and users be determined with precision. Instead, when determined at multiple times, approximate locations can provide very reliable (e.g. high confidence level) results about interrelationships of individual items and individual users. For instance, the approximate locations of the users and items could be a circle having a diameter of 1-5 meters. Multiple approximate locations can be evaluated over time to provide highly accurate inter-relationships.

The location information about the items and the users can be useful in other ways. For instance, rather than the scenario described above where user 122A(2) picks up item 102N and leaves the inventory control environment with the item, consider another scenario where the user puts the item back on another shelf at Time Three (T−3). This information can be used in multiple ways. First, the item is less likely to be purchased by another user when it is out of place. Also, it creates the appearance that inventory of that item is lower than it actually is. Further, if the item has special constraints, such as regulatory constraints, the location information can ensure that those constraints are satisfied. For instance, assume that the item is a refrigerated food item, such as a carton of milk that the user took out of the refrigerated environment at Time Two and put back on a non-refrigerated shelf at Time Three. The location information provides information of not only where the item is, but how long it has been there (e.g., when it was removed from the refrigerated environment). This information can allow appropriate measures to be taken in regards to the item. For instance, the item can be returned to the refrigerated environment within a specified time or disposed of after that time to avoid product degradation.

In another example, the item location information can be used to curtail nefarious behavior. For instance, if the item location information indicates that the item left the inventory control environment at a specific time, but no one paid for the item, this information can be used to identify system shortcomings (e.g., someone had it in their cart but the system failed to charge them for it). Alternatively, an individual user, such as a shopper or an employee may have taken active measures to leave without paying for the item. Various actions can be taken in such a case. For instance, if over time, multiple items leave the inventory control environment without being paid for, analysis of users leaving at the same time can indicate a pattern of a particular user leaving with items without permission (e.g., without paying for them). The present techniques can also provide a confidence level for each user leaving with the item. For instance, users one, two, and three all left the inventory control environment at the same time as the item. Based upon their locations through the inventory control environment and co-location with the item, the likelihood that user one has the item is 40%, user two 30%, and user three 20% (with a 10% chance that the none of them has the item). Looking at previous instances, user one has previously been associated with items ‘leaving’ the inventory control environment and so confidence levels can be adjusted to 60% for user one, 20% for user two, and 10% for user three, for example.

As mentioned above, the present inventory control concepts can be employed in many use case scenarios. In a manufacturing or construction scenario, the sensor fusion and co-location aspects can be used to track the user and items and/or other things. For instance, sensor fusion can be used to identify IoT devices and/or robots/AI devices. For example, sensor fusion can be used to sense parameters relating to appearance, size, weight, RF signature, power signature, etc. of these ‘devices.’ This information can be used to identify individual devices. Location of these devices can be determined (actual and/or relative to items and/or users) utilizing RF reading range, triangulation, RF phase change, Doppler shift, and/or inertial measurement units, among others. For example, Doppler shift can be used to determine whether the item is moving toward or away from an individual sensor. Alternatively or additionally, Doppler shift can be used to track local motion of the item/object, such as caused by arm swinging, and compare it with motion of arms in the scene using computer vision. Utilizing any combination of the above sensor data, the present concepts can be utilized to identify any kind of object or being, determine its location, and/or determine inter-relationships with other objects and/or beings.

Multiple beneficial examples of utilizing this knowledge are provided above, but other examples are contemplated. For instance, in the manufacturing/construction scenario, a user may leave the inventory control environment with an item, such as a tool. If the user does not have permission, appropriated steps can be taken, but more importantly, even if the user has permission, important steps can be taken to increase efficiency. For instance, the user may take the tool to another jobsite (e.g., another inventory control environment), but the tool may be needed the next day at this jobsite. The fact that the tool is no longer at the inventory control environment can allow appropriate action to be taken, such as obtaining a replacement tool so that process can be performed as planned the next day.

In another example, the inventory control concepts can be employed in a health care setting. For example, assume that the inventory control environment includes inventory areas, such as in a pharmacy, and a patient care area, and that both of these areas are covered by sensors throughout the inventory control environment. Assume, that a user (e.g., health care provider) such as a doctor prescribes a prescription medicine for the patient in room ‘814’ and enters this information into an inventory control/tracking system. The prescription medicine can be maintained in the inventory control environment. Another health care provider, such as a nurse can retrieve the prescription medicine. (This could occur directly or another health care provider, such as a pharmacist, may retrieve the prescription medicine and transfer it to the nurse). In either scenario, information from the sensors can identify that a user is now in possession of the prescription medicine, which health care provider possesses the prescription medicine, and/or the location of the prescription medicine within the health care facility.

Now assume that the nurse accidentally transposes the room number and enters patient room ‘841’ with the item (e.g., prescription medicine) rather than patient room ‘814.’ In such a case, within the inventory control environment, a location of an individual inventory control item has been identified and the location has been correlated to an individual (identified) user (this user is in possession of the item). As a result, actions can be automatically taken to prevent the prescription medicine from being administered to the wrong patient or otherwise mishandled. For instance, an alarm could be set off and/or a notice, such as a page or a text, could be sent to the nurse and/or the nurse's supervisor. Thus, without any user involvement or hassle, the inventory control environment can determine the location of items and who is in possession of individual items.

FIG. 4 shows a particle filter sensor fusion technique 400 that can utilize data from multiple sensors 110N that cover an inventory control environment 100B that includes inventory area 104B. This particle filter sensor fusion technique is explained relative to three users 122B(1), 122B(2), and 122B(3) and two items 102B(1) and 102B(2). Particle filter sensor fusion techniques can be employed to accurately determine which user 122B has which item 102B. Initially, either of two scenarios occurs. In Scenario One, user 122B(1) picks up item 102B(1) and user 122B(2) picks up item 102B(2). In Scenario Two, user 122B(1) picks up item 102B(2) and user 122B(2) picks up item 102B(1). Briefly, the particle filter sensor fusion technique 400 can determine first, which scenario actually occurred, and second whether user 102B(1) handed the item in his/her possession to user 122B(3).

Looking first at Scenario One and Scenario Two particle filter sensor fusion technique 400 can fuse data from sensors 110N to determine an initial probability for each scenario. For instance, the sensors can provide item weight, item location, item image, user biometrics, user gestures, etc. The sensor data can also include stored data from previous user interactions, such as user purchase history and/or other information about the user. For instance, stored data could indicate that user 122B(1) has purchased item 102B(1) in the past, but never item 102B(2) and conversely, user 122B(2) has purchased item 102B(2) in the past, but never item 102B(1). The particle filter sensor fusion technique 400 can utilize this data to determine the initial probability for each scenario at 402. In this example, for purposes of explanation, assume that the initial probability for Scenario One is 70% and the initial probability for Scenario Two is 30%.

The particle filter sensor fusion technique 400 can next address the possibility of a handoff from one user to another in the inventory control environment at 404. Specifically, the particle filter sensor fusion technique can determine the probability that user 122B(1) handed whatever item he/she has (indicated as 102B(?)) to user 122B(3) when they pass each other. Item 102B(?) is shown with a cross-hatching pattern that is the sum of the patterns of items 102B(1) and 102B(2) to indicate the identity of the item is not known with certainty. For purposes of explanation, the particle filter sensor fusion technique can determine an initial probability of the handoff at 406. In this example, for purposes of explanation, assume that the initial probability of a handoff is 50% (50% probability that user 122B(1) transferred item 102B(?) to user 122B(3) and 50% probability that he/she retains the item).

The particle filter sensor fusion technique 400 continues to analyze sensor data over time at 406. This analysis of sensor data over time can increase and refine the initial determinations. For instance, in the illustrated example, various sensors 110N can continue to track user 122B(1) to increase the reliability of the initial determination whether user 122B(1) has item 102B(1). In this example, this additional sensor data may allow the confidence that user 122B(1) has item 102B(1) to approach 100%. For instance, a threshold can be defined, such as 95%, for example. Thus, if the additional data sensed over time provides a confidence level that satisfies the threshold, then the analysis can be treated as determinative as indicating at 408 that user 122B(1) is in possession of item 102B(1). If the confidence level does not satisfy the threshold, additional resources can be employed at 410 to increase the confidence level. In this example, the additional resources can include a human assistant who reviews the sensed data and makes the determination about what (if any) item user 122B(1) possesses. (In another example, the additional resource can be additional processing resources). Thus, the additional resources can increase the confidence level about the threshold. With or without employing additional resources, a determination can be made with a confidence that satisfies the threshold that user 122B(1) is in possession of item 102B(1) at 412.

In that case, user 122B(1) did not hand off this item to user 122B(3) at 404. Thus, these percentages can be recalculated to reflect the probability of the handoff as 0%. Further, looking back to 402, because user 122B(1) has item 102B(1) the likelihood of Scenario One can be recalculated to 100% and the likelihood of scenario two can be recalculated to 0%. Further, given that Scenario One occurred at 402 and no handoff occurred at 406, a final determination can be made at 414 that user 122B(1) is in possession of item 102B(1), user 122B(2) is in possession of item 102B(2) and user 122B(3) is not in possession of either item 102B(1) or 102B(2). This information can be used at 416 to refine models applied to future scenarios in the inventory control environment to increase accuracy of determinations that individual users are in possession of individual items.

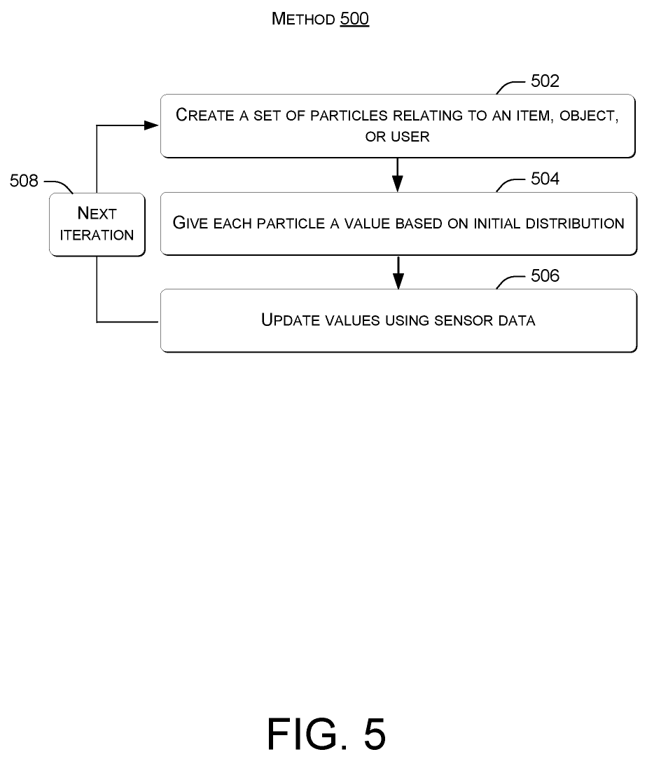

FIG. 5 shows a flowchart of a particle filter sensor fusion technique or method 500. For purposes of explanation, the technique will be explained relative to an example where the sensors comprise sensors positioned in the inventory control environment, such as cameras, as well as sensors on the user's smart phone, such as accelerometers and gyroscopes. Data from the sensors in the inventory control environment can be utilized to create a map of the inventory control environment (relative to x (horizontal), y (horizontal), and/or z (vertical) coordinates. Data from the sensors can be utilized to track the user through the inventory control environment. In this case, the method can model locations by creating a set of particles relating to an item, object, or user at 502. For instance, the method can initialize with all possible locations of the user (e.g., the user's smart phone) in the inventory control environment.

The method can give each particle a value based on initial distribution at 504. Initial distribution could start equally between all particles. For instance, particle weight (w) can be expressed as: w (x,y)=1/total # live particles. For example, assume that there are three people in a region of the inventory control environment. In the beginning, the distribution may be 33% per person given that the method can equally distribute the probability percentage.

Then, the initial estimates can be updated using sensor data at 506. Thus, initial particle values can then be updated based upon sensor data from various sensor sources. For example, continuing with the above example, assume that the region that includes the three people is covered by cameras. For instance, using an input video stream from the cameras or a combination of sensors (ex. RFID tags), and using the formula above, the method can adjust the probabilistic formula for each individual to reflect the updated belief % (confidence level) of who is the person of interest. As an example, the input data would shift the probability of the users from 33%, 33%, 33% to 20%, 60%, 20%, for example, which means the method is identifying the second person with a 60% confidence level.

The above example, reflects utilizing information from the sensors to update the probability value. Given that sensor data can be sampled over time (e.g., a time series recording of all three individuals in this example), and the fact that the second user has now been identified with a 60% confidence level, the method can now back track to the history of the video stream to identify the unknown users at time zero, when their probability was equally weighted. Which means, effectively the method can change the probability of time zero from 33%, 33%, 33% to the new probability model of 20%, 60%, 20%. This brings a level of accuracy to the system using future probability values for historical events.

The updated weights can supplant the assigned weights in the next iteration at 508. Thus, the user's location can be tracked (e.g., as a path) as the user progresses through the inventory control environment.

Another example can relate to RFID sensors. Multiple RFID sensors can be positioned in the inventory control environment, such as in the example of FIGS. 1A-1D described above. The RFID readers can be pre-trained to obtain their sensing patterns (sensing a region of the inventory control environment alone and/or sensing a shared region with overlapping patterns). An RFID tag (attached to an item) that is sensed in a region can be sampled as a set of particles. The particle locations can be updated based on new reading signal strengths and/or reading patterns. The particles can be trimmed based on map constraints of the inventory control environment. A path of the surviving particles has a high likelihood of corresponding to the path of the RFID tag. The path of the RFID tag can be compared to the path of the users, such as determined via the example above. The degree of correlation between the path of the RFID tag and the paths of the users can be indicative that an individual user is in possession of the RFID tag (and hence the item).

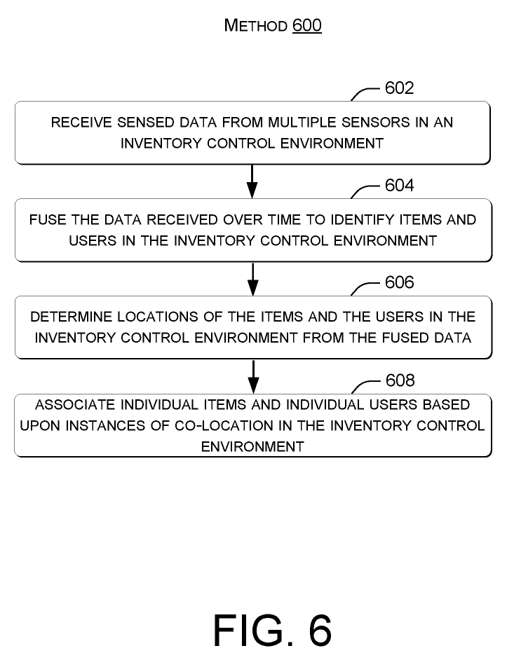

FIG. 6 illustrates a flowchart of sensor fusion inventory control technique or method 600.

The method can receive sensed data from multiple sensors in an inventory control environment at block 602. The multiple sensors can all be of the same sensor type or the sensors can include sensors from different sensor types. For instance, in the examples described above, sensor types include RFID sensors, NFC sensors, cameras, scales, accelerometers, and gyroscopes, among others. Receiving sensed data can also entail receiving stored data, such as previously sensed data, and/or data about the users, such as stored biometric data, shopping history, user profile and billing information, etc., and/or information about the inventory control environment, such as maps of the inventory control environment, sensor layout, inventory history, etc.

At block 604, the method can fuse the data received over time to identify items and users in the inventory control environment. Various techniques can be employed to fuse the data from the various sensors. In some cases, each type of sensor data can be weighted equally. In other cases, some sensors data can be weighted higher than other sensor data. For example, if the item is a pineapple, visual identification via camera data (e.g., images) may be highly accurate and determinative. In contrast, for a stack of similarly colored garments on a shelf, visual identification may provide low accuracy. Thus, in the former scenario involving the pineapple, camera data may be weighted higher than other types of sensor data. In contrast, in the latter scenario relating to garments, camera data may be weighted lower. The fusing can continue over a duration of time. Confidence in identification of users and items can increase over time with repeated sensing. Further, confidence in co-location of items and users and hence any interpreted association can increase over time.

The method can determine locations of the items and the users in the inventory control environment from the fused data at 606. Various examples are described above relative to FIGS. 1A-5.

The method can associate individual items and individual users based upon instances of co-location in the inventory control environment at 608. For instance, the locations can be overlaid to detect simultaneous co-location of individual items and individual users. The prognostic value of co-location increases as the individual user and the individual item are co-located along an extended path that culminates at an exit from the inventory control environment. In such a case, the association can be a presumption that the individual user is in possession of the individual item and intends to purchase the individual item. Thus, the individual user can be charged for the individual item when the associating continues until the individual user leaves the inventory control environment.

The described methods can be performed by the systems and/or elements described above and/or below, and/or by other inventory control devices and/or systems.

The order in which the methods are described is not intended to be construed as a limitation, and any number of the described acts can be combined in any order to implement the method, or an alternate method. Furthermore, the method can be implemented in any suitable hardware, software, firmware, or combination thereof, such that a device can implement the method. In one case, the method is stored on one or more computer-readable storage medium/media as a set of instructions (e.g., computer-readable instructions or computer-executable instructions) such that execution by a processor of a computing device causes the computing device to perform the method.

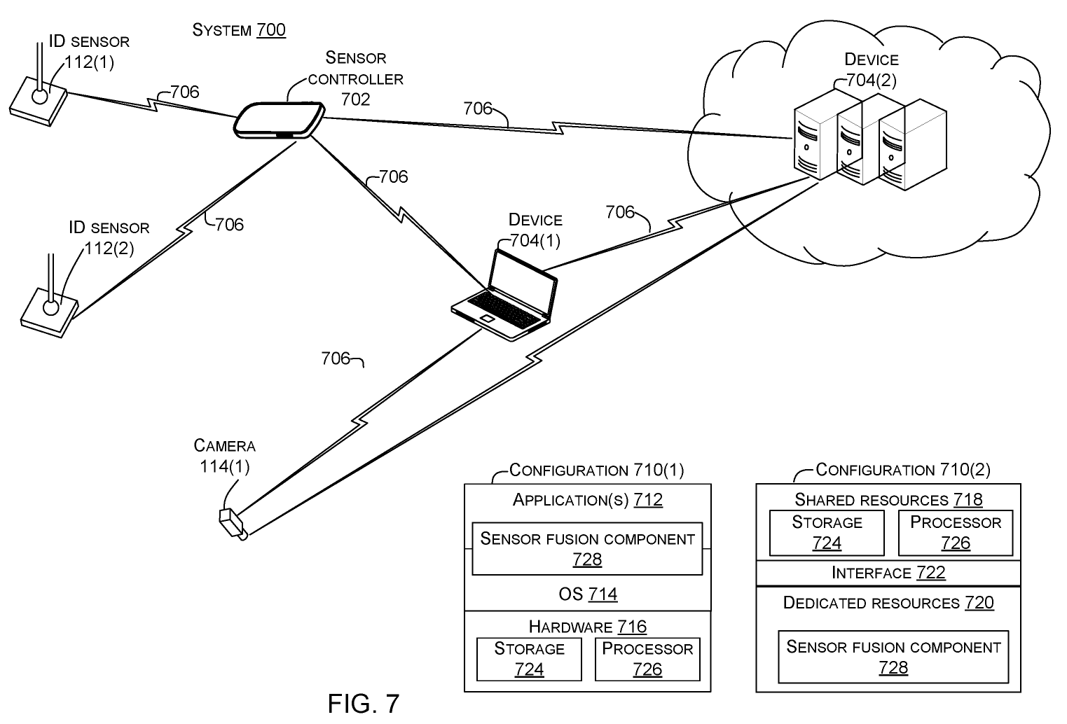

FIG. 7 shows a system 700 that can accomplish inventory control concepts. For purposes of explanation, system 700 includes sensors 110 represented by RFID sensors 112 and cameras 114. System 700 also includes a sensor controller 702. The sensor controller can coordinate function of and/or receive data from the sensors 1110. In implementations where the RFID sensors are manifest as RFID antennas, the sensor controller can be an RFID reader. The RFID reader can coordinate operations of the RFID antennas, such as when each RFID antenna transmits and at what power it transmits. System 700 can also include one or more devices 704. In the illustrated example, device 704(1) is manifest as a notebook computer device and example device 704(2) is manifest as a server device. In this case, the sensor controller 702 is freestanding. In other implementations, the sensor controller can be incorporated into device 704(1). The RFID sensors 112, camera 114, sensor controller 702, and/or devices 704 can communicate via one or more networks (represented by lightning bolts 706) and/or can access the Internet over the networks. In some cases, parentheticals are utilized after a reference number to distinguish like elements. Use of the reference number without the associated parenthetical is generic to the element. As illustrated relative to FIGS. 1A-1D, the RFID sensors 112 and cameras 114 are proximate to the inventory control environment. Sensor controller 702 and/or devices 704 can be proximate to the inventory control environment or remotely located. For instance, in one configuration, device 704(1) could be located proximate to the inventory control environment (e.g., in the same building), while device 704(2) is remote, such as in a server farm (e.g., cloud-based resource).

FIG. 7 shows two device configurations 710 that can be employed by devices 704. Individual devices 704 can employ either of configurations 710(1) or 710(2), or an alternate configuration. (Due to space constraints on the drawing page, one instance of each configuration is illustrated rather than illustrating the device configurations relative to each device 704). Briefly, device configuration 710(1) represents an operating system (OS) centric configuration. Configuration 710(2) represents a system on a chip (SOC) configuration. Configuration 710(1) is organized into one or more applications 712, operating system 714, and hardware 716. Configuration 710(2) is organized into shared resources 718, dedicated resources 720, and an interface 722 there between.

In either configuration 710, the device can include storage/memory 724, a processor 726, and/or a sensor fusion component 728. The sensor fusion component 728 can include a sensor fusion algorithm that can identify users and/or items by analyzing data from sensors 110. The sensor fusion component 728 can include a co-location algorithm that can identify locations over time (e.g., paths) of users and/or items by analyzing data from sensors 110. From the locations, the co-location algorithm can identify instances of co-location (e.g., same place same time) between items and users.

The sensor fusion component 728 can be configured to identify users and items and to detect when an item is moved from an inventory area. For instance, the sensor fusion component 728 can be configured to analyze data from the sensors 110 to identify items and users in the inventory control environment and to detect co-location of an individual user and an individual item at a first location in the inventory control environment at a first time and at a second location at a second time. For example, the sensor fusion component can be configured to process data from the set of ID sensors to track locations of an ID tagged inventory item from the first shared space to the second shared space, the sensor fusion component can be further configured to process images from the set of cameras to identify users in the inventory control environment. The sensor fusion component can be further configured to correlate the tracked locations of the ID tagged inventory item to simultaneous locations of an individual identified user.

In some configurations, each of devices 704 can have an instance of the sensor fusion component 728. However, the functionalities that can be performed by sensor fusion component 728 may be the same or they may be different from one another. For instance, in some cases, each device's sensor fusion component 728 can be robust and provide all of the functionality described above and below (e.g., a device-centric implementation). In other cases, some devices can employ a less robust instance of the sensor fusion component 728 that relies on some functionality to be performed remotely. For instance, device 704(2) may have more processing resources than device 704(1). In such a configuration, training data from ID sensors 112 may be sent to device 704(2). This device can use the training data to train the sensor fusion algorithm and/or the co-location algorithm. The algorithms can be communicated to device 704(1) for use by sensor fusion component 728(1). Then sensor fusion component 728(1) can operate the algorithms in real-time on data from sensors 110 to identify when an individual shopper is in possession of an individual item. Similarly, identification of users within the inventory control environment can be accomplished with data from cameras 114 through biometric analysis and/or comparison to stored data about the users. This aspect can be accomplished by sensor fusion component 728 on either or both of devices 704(1) and 704(2). Finally, correlation of individual items to identified users can be accomplished by sensor fusion component 728 on either or both device 704.

The term “device,” “computer,” or “computing device” as used herein can mean any type of device that has some amount of processing capability and/or storage capability. Processing capability can be provided by one or more processors that can execute data in the form of computer-readable instructions to provide a functionality. Data, such as computer-readable instructions and/or user-related data, can be stored on storage, such as storage that can be internal or external to the device. The storage can include any one or more of volatile or non-volatile memory, hard drives, flash storage devices, and/or optical storage devices (e.g., CDs, DVDs etc.), remote storage (e.g., cloud-based storage), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

Examples of devices 704 can include traditional computing devices, such as personal computers, desktop computers, servers, notebook computers, cell phones, smart phones, personal digital assistants, pad type computers, mobile computers, appliances, smart devices, IoT devices, etc. and/or any of a myriad of ever-evolving or yet to be developed types of computing devices.

As mentioned above, configuration 710(2) can be thought of as a system on a chip (SOC) type design. In such a case, functionality provided by the device can be integrated on a single SOC or multiple coupled SOCs. One or more processors 726 can be configured to coordinate with shared resources 718, such as memory/storage 724, etc., and/or one or more dedicated resources 720, such as hardware blocks configured to perform certain specific functionality. Thus, the term “processor” as used herein can also refer to central processing units (CPUs), graphical processing units (GPUs), controllers, microcontrollers, processor cores, or other types of processing devices.

Generally, any of the functions described herein can be implemented using software, firmware, hardware (e.g., fixed-logic circuitry), or a combination of these implementations. The term “component” as used herein generally represents software, firmware, hardware, whole devices or networks, or a combination thereof. In the case of a software implementation, for instance, these may represent program code that performs specified tasks when executed on a processor (e.g., CPU or CPUs). The program code can be stored in one or more computer-readable memory devices, such as computer-readable storage media. The features and techniques of the component are platform-independent, meaning that they may be implemented on a variety of commercial computing platforms having a variety of processing configurations.

Various examples are described above. Additional examples are described below. One example includes a system comprising a set of ID sensors positioned relative to an inventory control environment, a first subset of the ID sensors sensing a first shared space in the inventory control environment and a second different subset of ID sensors sensing a second shared space in the inventory control environment and a set of cameras positioned relative to the inventory control environment, a first subset of the cameras imaging the first shared space in the inventory control environment and a second different subset of the cameras imaging the second shared space in the inventory control environment. The system also comprises a processor configured to process information from the set of ID sensors to track locations of an ID tagged inventory item from the first shared space to the second shared space, the processor further configured to process images from the set of cameras to identify users in the inventory control environment, the processor further configured to correlate the tracked locations of the ID tagged inventory item to simultaneous locations of an individual identified user.

Another example can include any of the above and/or below examples where the ID tagged inventory item comprises an RFID tagged inventory item and the ID sensors of the set of ID sensors comprise RFID antennas.

Another example can include any of the above and/or below examples where the cameras of the set of cameras comprise visible light cameras or IR cameras and/or wherein the cameras comprise 3D cameras.

Another example can include any of the above and/or below examples where the processor is configured to process the images from the set of cameras to identify the users in the inventory control environment using biometrics.

Another example can include any of the above and/or below examples where the processor is configured to process the images from the set of cameras to identify the users in the inventory control environment using facial recognition.

Another example can include any of the above and/or below examples where the processor is configured to track locations of the ID tagged inventory item from the first shared space to the second shared space using Doppler shift to determine whether the ID tagged inventory item is moving toward or away from an individual ID sensor.

Another example can include any of the above and/or below examples where individual ID sensors of the first subset of the ID sensors have sensing regions that partially overlap to define the first shared space.

Another example can include any of the above and/or below examples where the processor is configured to simultaneously process information from multiple ID sensors of the set of ID sensors to reduce an influence of physical objects in the inventory control environment blocking signals from individual ID sensors.

Another example can include any of the above and/or below examples where the physical objects include users, shopping carts, and/or shelving.

Another example can include any of the above and/or below examples where the tracked locations of the ID tagged inventory item define a path of the ID tagged inventory item in the inventory control environment and the simultaneous locations define a path of the individual identified user in the inventory control environment.

Another example can include any of the above and/or below examples where the path of the ID tagged inventory is more co-extensive with the individual user than paths of other of the users in the inventory control environment.

Another example includes a system comprising multiple sensors positioned in an inventory control environment and a sensor fusion component configured to analyze data from the sensors to identify items and users in the inventory control environment and to detect co-location of an individual user and an individual item at a first location in the inventory control environment at a first time and at a second location in the inventory control environment at a second time.

Another example can include any of the above and/or below examples where the multiple sensors comprise multiple types of sensors.

Another example can include any of the above and/or below examples where the sensor fusion component is configured to fuse the data from the multiple types of sensors over time until a confidence level of the identified items exceeds a threshold.

Another example can include any of the above and/or below examples where the first location and the second location lie on a path of the individual user and a path of the individual item.

Another example includes a method comprising receiving sensed data from multiple sensors in an inventory control environment, fusing the data received over time to identify items and users in the inventory control environment, determining locations of the items and the users in the inventory control environment from the fused data, and associating individual items and individual users based upon instances of co-location in the inventory control environment.

Another example can include any of the above and/or below examples where the receiving sensed data comprises receiving sensed data from multiple different types of sensors.

Another example can include any of the above and/or below examples where the receiving sensed data further comprises receiving stored data from the inventory control environment.

Another example can include any of the above and/or below examples where the associating comprises charging the individual user (or otherwise receiving payment) for the individual item when the associating continues until the individual user leaves the inventory control environment.

Another example can include any of the above and/or below examples where the fusing continues over time until a confidence level of the identified users and items exceeds a threshold.

### CONCLUSION

Although the subject matter relating to inventory control has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A system, comprising:
a set of ID sensors positioned relative to an inventory control environment, a first subset of the ID sensors sensing a first shared space in the inventory control environment and a second different subset of ID sensors sensing a second shared space in the inventory control environment;
a set of cameras positioned relative to the inventory control environment, a first subset of the cameras imaging the first shared space in the inventory control environment and a second different subset of the cameras imaging the second shared space in the inventory control environment; and,
a processor configured to process information from the set of ID sensors to track locations of an ID tagged inventory item from the first shared space to the second shared space, the processor further configured to process images from the set of cameras to identify users in the inventory control environment, the processor further configured to correlate the tracked locations of the ID tagged inventory item to simultaneous locations of an individual identified user.

2. The system of claim 1, wherein the ID tagged inventory item comprises an RFID tagged inventory item and the ID sensors of the set of ID sensors comprise RFID antennas.

3. The system of claim 1, wherein the cameras of the set of cameras comprise visible light cameras and/or wherein the cameras comprise 3D cameras.

4. The system of claim 1, wherein the processor is configured to process the images from the set of cameras to identify the users in the inventory control environment using biometrics.

5. The system of claim 4, wherein the processor is configured to process the images from the set of cameras to identify the users in the inventory control environment using facial recognition.

6. The system of claim 1, wherein the processor is configured to track locations of the ID tagged inventory item from the first shared space to the second shared space using Doppler shift to determine whether the ID tagged inventory item is moving toward or away from an individual ID sensor.

7. The system of claim 1, wherein individual ID sensors of the first subset of the ID sensors have sensing regions that partially overlap to define the first shared space.

8. The system of claim 1, wherein the processor is configured to simultaneously process information from multiple ID sensors of the set of ID sensors to reduce an influence of physical objects in the inventory control environment blocking signals from individual ID sensors.

9. The system of claim 8, wherein the physical objects include users, shopping carts, and/or shelving.

10. The system of claim 1, wherein the tracked locations of the ID tagged inventory item define a path of the ID tagged inventory item in the inventory control environment and the simultaneous locations define a path of the individual identified user in the inventory control environment.

11. The system of claim 10, wherein the path of the ID tagged inventory is more co-extensive with the individual user than paths of other of the users in the inventory control environment.

12. A system, comprising:
multiple sensors positioned in an inventory control environment; and,
a sensor fusion component configured to analyze data from the sensors to identify items and users in the inventory control environment and to detect co-location of an individual user and an individual item at a first location in the inventory control environment at a first time and at a second location in the inventory control environment at a second time.

13. The system of claim 12, wherein the multiple sensors comprise multiple types of sensors.

14. The system of claim 13, wherein the sensor fusion component is configured to fuse the data from the multiple types of sensors over time until a confidence level of the identified items exceeds a threshold.

15. The system of claim 12, wherein the first location and the second location lie on a path of the individual user and a path of the individual item.

16. A method, comprising:
receiving sensed data from multiple sensors in an inventory control environment;
fusing the data received over time to identify items and users in the inventory control environment;
determining locations of the items and the users in the inventory control environment from the fused data; and,
associating individual items and individual users based upon instances of co-location in the inventory control environment.

17. The method of claim 16, wherein the receiving sensed data comprises receiving sensed data from multiple different types of sensors.

18. The method of claim 16, wherein the receiving sensed data further comprises receiving stored data from the inventory control environment.

19. The method of claim 16, wherein the associating comprises charging the individual user for the individual item when the associating continues until the individual user leaves the inventory control environment.

20. The method of claim 16, wherein the fusing continues over time until a confidence level of the identified users and items exceeds a threshold.
